(19) United States
(12) Patent Application Publication
(10) Pub. No.: US 2025/0008530 A1
(43) Pub. Date: Jan. 2, 2025

(54) METHOD AND DEVICE IN NODS USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/827,879

(22) Filed: Sep. 9, 2024

Related U.S. Application Data
(63) Continuation of application No. PCT/CN2023/081921, filed on Mar. 16, 2023.

(30) Foreign Application Priority Data
Mar. 21, 2022 (CN) 202210276725.8

(51) Int. Cl. H04W 72/232; H04L 5/00; H04W 72/231

(52) U.S. Cl. CPC H04W 72/232; H04L 5/0053; H04L 5/0094; H04L 5/0098; H04W 72/231

(57) ABSTRACT

A node first receives a first signaling, the first signaling is used to determine K parameter group sets, and each of the K parameter group sets comprising at least one first-type parameter group is used to configure a non-dynamic transmission; then receives a first DCI, the first DCI comprises K bit groups; the K bit groups correspond one-to-one with the K parameter group sets; any of the K bit groups is used to enable or disable a validation of the non-dynamic transmission; a given bit group in the K bit groups being used to enable or disable a validation of the non-dynamic transmission is unrelated to a value of a bit group other than the given bit group in the K bit groups; the present application improves the activation or release of the non-dynamic transmission under multicarrier scheduling to enhance system flexibility.

### CROSS REFERENCE TO RELATED APPLICATIONS

The present application is the continuation of the international patent application No. PCT/CN2023/081921, filed on March 16,2023, and claims the priority benefit of Chinese Patent Application No. 202210276725.8, filed on March 21,2022, the full disclosure of which is incorporated herein by reference.

### BACKGROUND

### Technical Field

The present application relates to transmission methods and devices in wireless communication systems, and in particular to a transmission method and device for multicarrier scheduling in wireless communications.

### Related Art

Both LTE (Long-Term Evolution) and 5G wireless cellular communication network systems support the scenario where multiple carriers are scheduled at the same time. In the multicarrier scheduling scenario, the base station increases the transmission rate by transmitting multiple Downlink Control Information (DCI) to schedule Physical Downlink Shared Channels (PDSCHs) on multiple carriers. A feature in the multicarrier scheduling is that each PDSCH requires one DCI for scheduling, and one DCI cannot schedule multiple PDSCHs located on multiple carriers at the same time.

In the discussion of NR R17, the topic of scheduling a PDSCH or PUSCH (Physical Uplink Shared Channel) on multiple carriers based on a single DCI was set up, and accordingly, the solution of how to schedule the PDSCH or PUSCH on multiple carriers through a DCI needs to be studied and discussed.

### SUMMARY

An important enhancement in 5G NR is the introduction of the concept of BWP (Bandwidth Part), a serving cell often comprises multiple BWPs, each BWP can be configured with a different SCS (Subcarrier Spacing) or independently with DL SPS (Semi-persistent Scheduling) or with configured UL Grant Type 2 scheduling, and the base station uses DCI (Downlink Control Information) to activate or release one or multiple DL SPSs or uplink Configured Grant functions.

When a DCI is capable of scheduling PDSCH or PUSCH transmission on multiple carriers, a DCI should also be capable of activating or releasing DL SPS or uplink configured grant on multiple carriers, and thus how to implement the above functions based on existing DCI formats and protocol architectures is something that needs to be investigated and addressed.

The present application discloses a solution for the multicarrier scheduling scenario described above. It should be noted that in the description of the present application, multicarrier is only used as a typical application scenario or example; the present application is equally applicable to other scenarios facing similar problems, e.g., single-carrier scenarios, or for different technical fields, e.g., technical fields other than dynamic scheduling, and other non-dynamic scheduling fields, such as measurement reporting, control signaling transmission, where similar technical effects can be achieved. Additionally, the adoption of a unified solution for various scenarios, including but not limited to scenarios of multi-panel, contributes to the reduction of hardware complexity and costs. If no conflict is incurred, embodiments in a first node in the present application and the characteristics of the embodiments are also applicable to a second node, and vice versa. Particularly, for interpretations of the terminology, nouns, functions and variants (if not specified) in the present application, refer to definitions given in Technical Specification (TS) 36 series, TS38 series and TS37 series of 3GPP specifications.

The present application provides a method in a first node for wireless communications, comprising:
receiving a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
receiving a first DCI, the first DCI comprising K bit groups, any of the K bit groups comprising at least one bit;
herein, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, one feature of the above method is in: activating or releasing non-dynamic transmissions on multiple serving cells through a DCI to improve system efficiency and reduce bandwidth consumption incurred by control signalings.

In one embodiment, another feature of the above method is in: indicating non-dynamic transmissions on multiple serving cells through separate multiple fields in a single DCI to ensure flexibility of indication.

According to one aspect of the present application, the first DCI comprises a target bit group other than the K bit groups, and only when all the K bit groups are used to disable the validation of the non-dynamic transmission, the target bit group is used to disable the validation of the non-dynamic transmission.

In one embodiment, one feature of the above method is in: when non-dynamic transmissions in multiple serving cells indicated by the first DCI are released, the target bit group is used for the overall validation of the K bit groups, thereby saving a number of bit(s) occupied by the first DCI and improving spectral efficiency.

In one embodiment, another feature of the above method is in: payload of the first DCI is related to whether the K bit groups are used simultaneously for the release of non-dynamic transmissions of multiple serving cells, thus improving the spectral efficiency while ensuring the flexibility.

According to one aspect of the present application, comprising:
receiving a first signal;
herein, the K bit groups comprised in the first DCI comprise a first bit group, the first bit group corresponds to a first parameter group set in the K parameter group sets, the first bit group is used to enable a non-dynamic transmission configured by at least one first-type parameter group comprised in the first parameter group set, and the first-type parameter group comprised in the first parameter group set is used to configure the first signal.

In one embodiment, one feature of the above method is in: there exists one bit group used for DL SPS activation among the K bit groups.

According to one aspect of the present application, comprising:
transmitting a second signal;
herein, the K bit groups comprised in the first DCI comprise a second bit group, the second bit group corresponds to a second parameter group set in the K parameter group sets, the second bit group is used to enable a non-dynamic transmission configured by at least one first-type parameter group comprised in the second parameter group set, and the first-type parameter group comprised in the second parameter group set is used to configure the second signal.

In one embodiment, one feature of the above method is in: there exists one bit group used for uplink configured grant activation among the K bit groups.

According to one aspect of the present application, the K parameter group sets respectively correspond to K BWPs in K serving cells, and all the K BWPs use a same subcarrier spacing.

In one embodiment, one feature of the above method is in: avoiding the problem of inconsistent validation times between different BWPs incurred by different SCSs (Subcarrier Spacings).

According to one aspect of the present application, the K BWPs are predefined in the K serving cells or configured through an RRC (Radio Resource Control) signaling.

In one embodiment, one feature of the above method is in: configuring DL SPS or uplink configured grants with same characteristics for BWP used for joint scheduling in multiple serving cells to facilitate joint activation or release.

According to one aspect of the present application, the K serving cells respectively correspond to K scheduling indicator values, and all K scheduling indicator values are the same.

The present application provides a method in a second node for wireless communications, comprising:
transmitting a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
transmitting a first DCI, the first DCI comprising K bit groups, any of the K bit groups comprising at least one bit;
herein, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

According to one aspect of the present application, the first DCI comprises a target bit group other than the K bit groups, and only when all the K bit groups are used to disable the validation of the non-dynamic transmission, the target bit group is used to disable the validation of the non-dynamic transmission.

According to one aspect of the present application, comprising:
transmitting a first signal;
herein, the K bit groups comprised in the first DCI comprise a first bit group, the first bit group corresponds to a first parameter group set in the K parameter group sets, the first bit group is used to enable a non-dynamic transmission configured by at least one first-type parameter group comprised in the first parameter group set, and the first-type parameter group comprised in the first parameter group set is used to configure the first signal.

According to one aspect of the present application, comprising:
receiving a second signal;
herein, the K bit groups comprised in the first DCI comprise a second bit group, the second bit group corresponds to a second parameter group set in the K parameter group sets, the second bit group is used to enable a non-dynamic transmission configured by at least one first-type parameter group comprised in the second parameter group set, and the first-type parameter group comprised in the second parameter group set is used to configure the second signal.

According to one aspect of the present application, the K parameter group sets respectively correspond to K BWPs in K serving cells, and all the K BWPs use a same subcarrier spacing.

According to one aspect of the present application, the K BWPs are predefined in the K serving cells or configured through an RRC signaling.

According to one aspect of the present application, the K serving cells respectively correspond to K scheduling indicator values, and all K scheduling indicator values are the same.

The present application provides a first node for wireless communications, comprising:
a first receiver, receiving a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
a first transceiver, receiving a first DCI, the first DCI comprising K bit groups, any of the K bit groups comprising at least one bit;
herein, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

The present application provides a second node for wireless communications, comprising:
a first transmitter, transmitting a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
a second transceiver, transmitting a first DCI, the first DCI comprising K bit groups, any of the K bit groups comprising at least one bit;
herein, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, advantages of the scheme in the present application are: one or more DL SPS or uplink configured grants in multiple serving cells are flexibly activated or released by a single DCI to improve spectral efficiency and reduce signaling overhead.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of a first signaling according to one embodiment of the present application;

FIG. 6 illustrates a flowchart of a first signal according to one embodiment of the present application;

FIG. 7 illustrates a flowchart of a second signal according to one embodiment of the present application;

FIG. 8 illustrates a schematic diagram of K parameter group sets according to one embodiment of the present application;

FIG. 9 illustrates a schematic diagram of K bit groups according to one embodiment of the present application;

FIG. 10 illustrates a schematic diagram of a target bit group according to one embodiment of the present application;

FIG. 11 illustrates a schematic diagram of a non-dynamic transmission according to one embodiment of the present application;

FIG. 12 illustrates a structure block diagram of a processor in a first node according to one embodiment of the present application;

FIG. 13 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

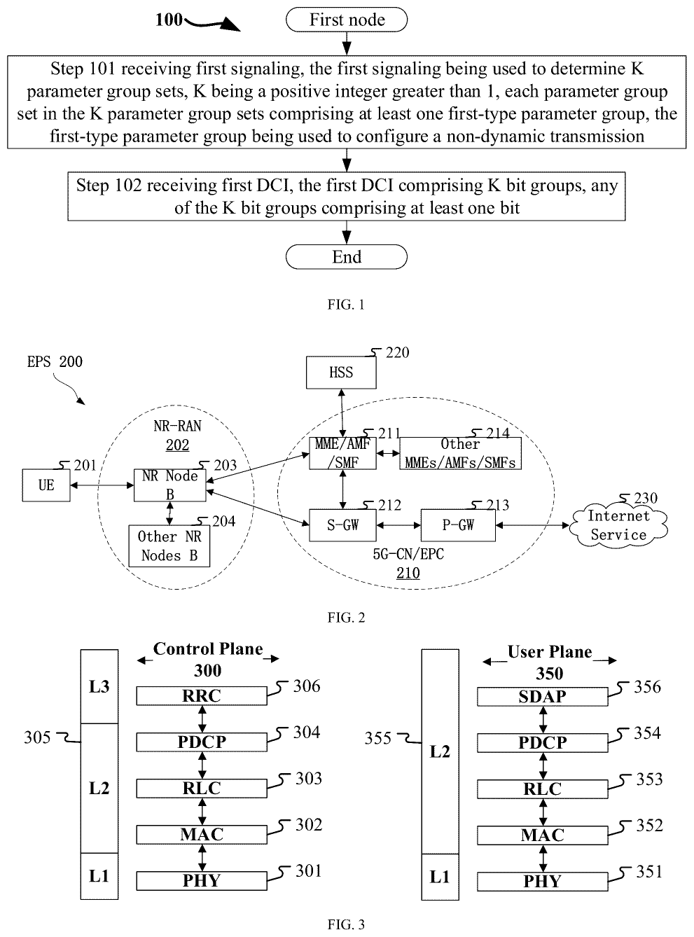

Embodiment 1 illustrates a flowchart of processing of a first node, as shown in FIG. 1. In step 100 illustrated by FIG. 1, each box represents a step. In embodiment 1, the first node in the present application receives a first signaling in step 101, the first signaling is used to determine K parameter group sets, K being a positive integer greater than 1, each parameter group set in the K parameter group sets respectively comprise at least one first-type parameter group, and the first-type parameter group is used to configure a non-dynamic transmission; in step 102, receives the first DCI, the first DCI comprises K bit groups, and any of the K bit groups comprises at least one bit.

In embodiment 1, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the first signaling comprises a higher-layer signaling.

In one embodiment, the first signaling comprises an RRC signaling.

In one embodiment, the first signaling comprises one or multiple fields in RRC signaling ConfiguradGrantConfig IE (Information Element).

In one embodiment, the first signaling comprises one or multiple fields in RRC signaling SPS-Config IE.

In one embodiment, the first signaling comprises one or multiple fields in RRC signaling BWP-DownlinkDedicated.

In one embodiment, the first signaling comprises one or multiple fields in RRC signaling BWP-UplinkDedicated.

In one embodiment, the first signaling comprises one or multiple fields in RRC signaling ServingCellConfig IE.

In one embodiment, the first signaling comprises one or multiple fields in RRC signaling CellGroupConfig IE.

In one embodiment, the first signaling comprises multiple ServingCellConfig IEs.

In one embodiment, the first signaling comprises K ServingCellConfig IEs, and the K ServingCellConfig IEs respectively corresponding to K serving cells.

In one embodiment, the first signaling comprises K ServingCellConfig IEs, and the K ServingCellConfig IEs respectively correspond to K Component Carriers (CCs).

In one embodiment, the K parameter group sets respectively correspond to K serving cells.

In one embodiment, the K parameter group sets respectively correspond to K CCs (Component Carriers).

In one embodiment, the K parameter group sets respectively correspond to K BWPs.

In one embodiment, the K parameter group sets respectively comprise K DL SPS sets, and any DL SPS set in the K DL SPS sets comprises at least one DL SPS corresponding to SPS-Config.

In one subembodiment of the above embodiment, the K DL SPS sets respectively correspond to K serving cells.

In one subembodiment of the above embodiment, the K DL SPS sets respectively correspond to K CCs.

In one embodiment, the K parameter group sets respectively comprise K ConfiguredGrantConfig sets, and any of the K ConfiguredGrantConfig sets comprises at least one UL configured grant corresponding to ConfiguradGrantConfig.

In one subembodiment of the above embodiment, the K ConfiguredGrantConfig sets respectively correspond to K serving cells.

In one subembodiment of the above embodiment, the K ConfiguredGrantConfig sets respectively correspond to K CCs.

In one embodiment, the K parameter group sets respectively comprise K non-dynamic transmission sets, the K non-dynamic transmission sets at least comprise one given non-dynamic transmission set, and the given non-dynamic transmission set comprises at least one DL SPS corresponding to SPS-Config and at least one UL configured grant corresponding to ConfiguradGrantConfig.

In one embodiment, the first-type parameter group is for an SPS-Config IE.

In one embodiment, the first-type parameter group is for an sps-ConfigIndex.

In one embodiment, the first-type parameter group is for a ConfiguredGrantConfig IE.

In one embodiment, the first-type parameter group is for a configuredGrantConfigIndex.

In one embodiment, the first-type parameter group is for a configuredGrantConfigIndexMAC.

In one embodiment, the non-dynamic transmission comprises multiple transmissions.

In one embodiment, the non-dynamic transmission is executed periodically.

In one embodiment, the non-dynamic transmission is activated through a dynamic signaling.

In one embodiment, the non-dynamic transmission is disabled or released through a dynamic signaling.

In one embodiment, the non-dynamic transmission comprises multiple transmissions, and at least one of the multiple transmissions does not require a dynamic signaling indication.

In one embodiment, the non-dynamic transmission comprises SPS.

In one embodiment, the non-dynamic transmission comprises Configured Grant.

In one embodiment, the non-dynamic transmission comprises DL SPS.

In one embodiment, the non-dynamic transmission comprises Configured UL Grant Type 2 scheduling.

In one embodiment, the first DCI is a DCI.

In one embodiment, the first DCI is a PDCCH (Physical Downlink Control Channel).

In one embodiment, the first DCI is transmitted in only one CC.

In one embodiment, the first DCI is transmitted in only one serving cell.

In one embodiment, the first DCI is used to schedule multiple serving cells.

In one embodiment, a Cyclic Redundancy Check (CRC) comprised in a PDCCH occupied by the first DCI is scrambled by a CS-RNTI (Configured Scheduling RNTI).

In one embodiment, the enable comprises Activate.

In one embodiment, the enable comprises Trigger.

In one embodiment, the disable comprises Deactivate.

In one embodiment, the disable comprises Release.

In one embodiment, the validation comprises Validation.

In one embodiment, the validation comprises Confirmation.

In one embodiment, any of the K bit groups is used to indicate one or multiple first-type parameter groups comprised in a corresponding parameter group set in the K parameter group set.

Typically, at least two of the K bit groups are respectively used to enable and disable at least one first-type parameter group in a corresponding parameter group set.

In one embodiment, the K bit groups comprise a first candidate bit group and a second candidate bit group, the first candidate bit group and the second candidate bit group respectively correspond to a first candidate parameter group set and a second candidate parameter group set in the K parameter group sets, the first candidate bit group is used to enable a corresponding non-dynamic transmission in the first candidate parameter group set, and the second candidate bit group is used to disable a corresponding non-dynamic transmission in the second candidate parameter group set.

In one subembodiment of the embodiment, the first candidate parameter group set comprises K1 first-type parameter group(s), the first candidate bit group is used to indicate K2 first-type parameter group(s) in the K1 first-type parameter group(s), K1 being a positive integer, K2 being a positive integer not greater than the K1, and the first candidate bit group is used to enable K2 non-dynamic transmission(s) corresponding to K2 first-type parameter group(s).

In one subembodiment of the embodiment, the second candidate parameter group set comprises Q1 second-type parameter group(s), the second candidate bit group is used to indicate Q2 first-type parameter group(s) in the Q1 first-type parameter group(s), Q1 being a positive integer, Q2 being a positive integer not greater than Q1, and the second candidate bit group is used to disable Q2 non-dynamic transmission(s) corresponding to the Q2 first-type parameter group(s).

Typically, the K parameter group sets are respectively allocated to K BWPs, and the K bit groups are respectively used to indicate the K BWPs.

Typically, the K parameter group sets are respectively allocated to K serving cells, and the K bit groups are respectively used to indicate the K serving cells.

Typically, the K parameter group sets are respectively allocated to K carriers, and the K bit groups are respectively used to indicate the K carriers.

In one embodiment, the meaning of the phrase that a given bit group in the K bit groups being used to enable or disable a validation of the non-dynamic transmission is unrelated to a value of a bit group other than the given bit group in the K bit groups comprises: the K bit groups are used to independently enable or disable a validation of a non-dynamic transmission comprised in the K parameter group sets.

In one embodiment, advantages of the phrase that the given bit group in the K bit groups is used to enable or disable a validation of the non-dynamic transmission is unrelated to a value of a bit group other than the given bit group in the K bit groups comprise: being capable of flexibly enabling or disabling the transmission of DL SPS or configured UL Grant Type 2 scheduling in different carriers, without affecting multiple bit groups for different carriers, so as to improve accuracy.

In one embodiment, advantages of the phrase that the given bit group in the K bit groups is used to enable or disable a validation of the non-dynamic transmission is unrelated to a value of a bit group other than the given bit group in the K bit groups comprise: being capable of independently enabling or disabling non-dynamic transmissions on multiple serving cells or BWPs, and a bit group for a serving cell or BWP will not be affected by the bit group for other serving cells or BWPs, so as to improve independence.

In one embodiment, the meaning of at least one first-type parameter group in a corresponding parameter group set being adopted includes: the corresponding parameter group set comprises a given first-type parameter group, the given first-type parameter group comprises multiple parameters, the multiple parameters comprises at least one of a number of HARQ (Hybrid Automatic Repeat reQuest) processes, PUCCH (Physical Uplink Control Channel) resource indication, MCS (Modulation Coding Scheme) table, HRAQ process number offset, periodic configuration, HARQ codebook identifier, or aggregation factor, and at least one of the multiple parameters is used to determine a data reception of a non-dynamic transmission corresponding to the given first-type parameter group.

In one subembodiment of the above embodiment, the non-dynamic transmission corresponds to a DL SPS.

In one subembodiment of the above embodiment, the number of HARQ processes is used to determine a number of HARQ processes occupied by the non-dynamic transmission.

In one subembodiment of the above embodiment, the number of HARQ processes corresponds to a nrofHARQ-Processes field in SPS-Config IE.

In one subembodiment of the above embodiment, the PUCCH resource indication is used to determine a PUCCH occupied by HARQ resources for the non-dynamic transmission.

In one subembodiment of the above embodiment, the PUCCH resource indication corresponds to a n1PUCCH-AN field in SPS-Config IE.

In one subembodiment of the above embodiment, the MCS table is used to determine an MCS table adopted for the non-dynamic transmission.

In one subembodiment of the above embodiment, the MCS table corresponds to an mcs-Table field in SPS-Config IE.

In one subembodiment of the above embodiment, the HRAQ process number offset is used to indicate an offset value used to obtain a HARQ process ID for the non-dynamic transmission.

In one subembodiment of the above embodiment, the HRAQ process number offset corresponds to a harq-ProcID-Offset field in SPS-Config IE.

In one subembodiment of the above embodiment, the periodic configuration is used to indicate a period of the non-dynamic transmission.

In one subembodiment of the above embodiment, the periodic configuration corresponds to a periodicity field in SPS-Config IE.

In one subembodiment of the above embodiment, the periodic configuration corresponds to a periodicityExt field in SPS-Config IE.

In one subembodiment of the above embodiment, the HARQ codebook identifier is used to indicate a HARQ-ACK codebook index of a HARQ-ACK codebook adopted for the non-dynamic transmission.

In one subembodiment of the above embodiment, the HARQ codebook identifier corresponds to a harq-CodebookID field in SPS-Config IE.

In one subembodiment of the above embodiment, the aggregation factor is used to indicate a number of repetition(s) of SPS PDSCH adopted for the non-dynamic transmission.

In one subembodiment of the above embodiment, the aggregation factor corresponds to a pdsch-AggregationFactor field in SPS-Config IE.

In one embodiment, the meaning of at least one first-type parameter group in a corresponding parameter group set is stopped from being adopted includes: the corresponding parameter group set comprises a given first-type parameter group, the given first-type parameter group comprises multiple parameters, the multiple parameters comprises at least one of a number of HARQ (Hybrid Automatic Repeat reQuest) processes, PUCCH (Physical Uplink Control Channel) resource indication, MCS (Modulation Coding Scheme) table, HRAQ process number offset, periodic configuration, HARQ codebook identifier, or aggregation factor, and at least one of the multiple parameters is used to determine that a data reception of a non-dynamic transmission corresponding to the given first-type parameter group is stopped.

In one subembodiment of the above embodiment, the number of HARQ processes is used to determine that a number of HARQ processes occupied by the non-dynamic transmission is no longer occupied.

In one subembodiment of the above embodiment, the PUCCH resource indication is used to determine that a PUCCH occupied by HARQ resources for the non-dynamic transmission is no longer occupied.

In one subembodiment of the above embodiment, the periodic configuration is used to indicate that periodic time-domain resources occupied by the non-dynamic transmission are no longer occupied.

In one subembodiment of the above embodiment, the HARQ codebook identifier is used to indicate that a HARQ-ACK codebook under a HARQ-ACK codebook index adopted for the non-dynamic transmission is no longer occupied.

In one embodiment, the meaning of adopting at least one first-type parameter group in a corresponding parameter group set includes: the corresponding parameter group set comprises a given first-type parameter group, the given first-type parameter group comprises multiple parameters, the multiple parameters comprise at least one field in ConfiguredGrantConfig IE, and at least one of the multiple parameters is used to determine a data transmission of a non-dynamic transmission corresponding to the given first-type parameter group.

In one subembodiment of the above embodiment, at least one parameter in the multiple parameters is used to determine frequency-domain resources occupied by the non-dynamic transmission, and the frequency-domain resources comprise at least one of an RB (Resource Block), an RB set, or an RBG (Resource Block Group).

In one subembodiment of the above embodiment, at least one parameter in the multiple parameters is used to determine time-domain resources occupied by the non-dynamic transmission, and the time-domain resources comprise at least one of slot or OFDM symbol.

In one subembodiment of the above embodiment, at least one of the multiple parameters is used to determine a number of HARQ processes occupied by the non-dynamic transmission.

In one subembodiment of the above embodiment, at least one of the multiple parameters is used to determine a HARQ process number occupied by the non-dynamic transmission.

In one subembodiment of the above embodiment, at least one of the multiple parameters is used to determine an antenna port occupied by the non-dynamic transmission.

In one subembodiment of the above embodiment, at least one of the multiple parameters is used to determine a DMRS configuration adopted for the non-dynamic transmission.

In one subembodiment of the above embodiment, at least one of the multiple parameters is used to determine a period adopted for the non-dynamic transmission.

In one subembodiment of the above embodiment, at least one of the multiple parameters is used to determine a priority adopted for the non-dynamic transmission.

In one subembodiment of the above embodiment, at least one of the multiple parameters is used to determine a power control parameter adopted for the non-dynamic transmission.

In one subembodiment of the above embodiment, at least one of the multiple parameters is used to determine repetitions adopted for the non-dynamic transmission.

In one subembodiment of the above embodiment, at least one of the multiple parameters is used to determine RV Sequence adopted for the non-dynamic transmission.

In one subembodiment of the above embodiment, at least one of the multiple parameters is used to determine SRS (Sounding Reference Signal) resources adopted for the non-dynamic transmission.

In one embodiment, the meaning of at least one first-type parameter group in a corresponding parameter group set is stopped from being adopted includes: the corresponding parameter group set comprises a given first-type parameter group, the given first-type parameter group comprises multiple parameters, the multiple parameters comprise at least one field in ConfiguredGrantConfig IE, and at least one of the multiple parameters is used to determine that the a data transmission of a non-dynamic transmission corresponding to the given first-type parameter group is stopped.

In one subembodiment of the above embodiment, at least one of the multiple parameters is used to determine that frequency-domain resources occupied by the non-dynamic transmission are no longer occupied, and the frequency-domain resources comprise at least one of an RB, an RB set, or an RBG.

In one subembodiment of the above embodiment, at least one of the multiple parameters is used to determine that time-domain resources occupied by the non-dynamic transmission are no longer occupied, and the time-domain resources comprise at least one of slot or OFDM symbol.

In one subembodiment of the above embodiment, at least one of the multiple parameters is used to determine that a number of HARQ processes occupied by the non-dynamic transmission is no longer occupied.

In one subembodiment of the above embodiment, at least one of the multiple parameters is used to determine that a HARQ process number occupied by the non-dynamic transmission is no longer occupied.

In one subembodiment of the above embodiment, at least one of the multiple parameters is used to determine that an antenna port occupied by the non-dynamic transmission is no longer occupied.

In one subembodiment of the above embodiment, at least one of the multiple parameters is used to determine that DMRS resources corresponding to a DMRS (Modulation Reference Signal) configuration adopted for the non-dynamic transmission are no longer occupied.

In one subembodiment of the above embodiment, at least one of the multiple parameters is used to determine that time-domain resources corresponding to a period adopted for the non-dynamic transmission are no longer occupied.

In one subembodiment of the above embodiment, at least one of the multiple parameters is used to determine that SRS resources adopted for the non-dynamic transmission are no longer occupied.

### Embodiment 2

Embodiment 2 illustrates a schematic diagram of a network architecture, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise UE 201, an NR-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NR-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an Sl/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 supports multiple carriers to be scheduled by a same DCI.

In one embodiment, the UE 201 supports multiple serving cells to be scheduled by a same DCI.

In one embodiment, the UE 201 supports cross-carrier scheduling.

In one embodiment, the NR node B corresponds to the second node in the present application.

In one embodiment, the NR node B supports multiple carriers to be scheduled by a same DCI.

In one embodiment, the NR node B supports multiple serving cells to be scheduled by a same DCI.

In one embodiment, the NR node B supports cross-carrier scheduling.

In one embodiment, the NR node B is a base station.

In one embodiment, the NR node B is a cell.

In one embodiment, the NR node B comprises multiple cells.

In one embodiment, the NR node B is used to determine transmission on multiple serving cells.

In one embodiment, the first node in the present application corresponds to the UE 201, and the second node in the present application corresponds to the NR node B.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X) is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the first communication node and the second communication node via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and also provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transmission channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first signaling is generated by the MAC 302 or the MAC 352.

In one embodiment, the first signaling is generated by the RRC 306.

In one embodiment, the first DCI is generated by the PHY 301 or the PHY 351.

In one embodiment, the first DCI is generated by the MAC 302 or the MAC 352.

In one embodiment, the first signal is generated by the PHY 301 or the PHY 351.

In one embodiment, the first signal is generated by the MAC 302 or the MAC 352.

In one embodiment, the first signal is generated by the RRC 306.

In one embodiment, the second signal is generated by the PHY 301 or the PHY 351.

In one embodiment, the second signal is generated by the MAC 302 or the MAC 352.

In one embodiment, the second signal is generated by the RRC 306.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used to manage multiple TRPs.

In one embodiment, the second node is a node used for managing multiple cells.

In one embodiment, the second node is a node used for managing multiple serving cells.

### Embodiment 4

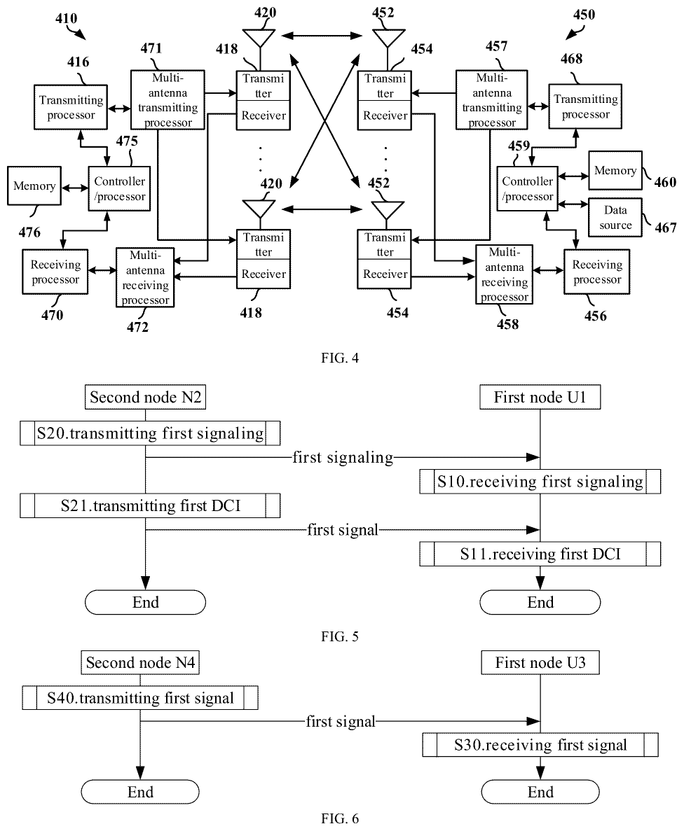

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transmission channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transmission channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transmission channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transmission channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: first receives a first signaling, the first signaling is used to determine K parameter group sets, K being a positive integer greater than 1, each of the K parameter group sets comprises at least one first-type parameter group, the first-type parameter group is used to configure a non-dynamic transmission; then receives a first DCI, the first DCI comprises K bit groups, any of the K bit groups comprises at least one bit; the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the first communication device 450 comprises at least one processor and at least one memory. a memory that stores a computer readable instruction program. The computer readable instruction program generates an action when executed by at least one processor. The action includes: first receiving a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; then receiving a first DCI, the first DCI comprising K bit groups, any of the K bit groups comprising at least one bit; the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: first transmits a first signaling, the first signaling is used to determine K parameter group sets, K being a positive integer greater than 1, each of the K parameter group sets comprises at least one first-type parameter group, the first-type parameter group is used to configure a non-dynamic transmission; then transmits a first DCI, the first DCI comprises K bit groups, any of the K bit groups comprises at least one bit; the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the second communication device 410 comprises a memory that stores a computer readable instruction program. The computer readable instruction program generates an action when executed by at least one processor. The action includes: first transmitting a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; then transmitting a first DCI, the first DCI comprising K bit groups, any of the K bit groups comprising at least one bit; the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is a network device.

In one embodiment, the second communication device 410 is a serving cell.

In one embodiment, the second communication device 410 is a TRP.

In one embodiment, at least first four of the antenna 452, the receiver 454, the multi-antenna receiving processor 458, the receiving processor 456 and the controller/processor 459 are used to receive a first signaling; at least first four of the antenna 420, the transmitter 418, the multi-antenna transmitting processor 471, the transmitting processor 416, and the controller/processor 475 are used to transmit a first signaling.

In one embodiment, at least first four of the antenna 452, the receiver 454, the multi-antenna receiving processor 458, the receiving processor 456 and the controller/processor 459 are used to receive first DCI; at least first four of the antenna 420, the transmitter 418, the multi-antenna transmitting processor 471, the transmitting processor 416 and the controller/processor 475 are used to transmit first DCI.

In one embodiment, at least first four of the antenna 452, the receiver 454, the multi-antenna receiving processor 458, the receiving processor 456 and the controller/processor 459 are used to receive a first signal; at least first four of the antenna 420, the transmitter 418, the multi-antenna transmitting processor 471, the transmitting processor 416 and the controller/processor 475 are used to transmit a first signal.

In one embodiment, at least first four of the antenna 452, the transmitter 454, the multi-antenna transmitting processor 457, the transmitting processor 468, and the controller/processor 459 are used to transmit a second signal; at least first four of the antenna 420, the receiver 418, the multi-antenna receiving processor 472, the receiving processor 470 and the controller/processor 475 are used to receive a second signal.

### Embodiment 5

Embodiment 5 illustrates a flowchart of a first signaling, as shown in FIG. 5. In FIG. 5, a first node U1 and a second node N2 are in communications via a radio link. It is particularly underlined that the order illustrated in the embodiment does not put constraints over sequences of signal transmissions and implementations. Embodiments, sub-embodiments and subsidiary embodiments of embodiment 5 can be applied to embodiment 6 or 7 if no conflict is incurred; conversely, embodiments, sub-embodiments, and subsidiary embodiments of either of embodiment 6 or embodiment 7 can be applied to embodiment 5 without conflict.

The first node U1 receives a first signaling in step S10; receives a first DCI in step S11.

The second node N2 transmits a first signaling in step S20; transmits a first DCI in step S21.

In embodiment 5, the first signaling is used to determine K parameter group sets, K being a positive integer greater than 1, each of the K parameter group sets comprises at least one first-type parameter group, the first-type parameter group is used to configure a non-dynamic transmission; the first DCI comprises K bit groups, any of the K bit groups comprises at least one bit; the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

Typically, the first DCI comprises a target bit group other than the K bit groups, and only when all the K bit groups are used to disable the validation of the non-dynamic transmission, the target bit group is used to disable the validation of the non-dynamic transmission.

Typically, the K parameter group sets are respectively allocated to K carriers, and the target bit group is applied to the K carriers.

Typically, the K parameter group sets are respectively allocated to K serving cells, and the target bit group is applied to the K serving cells.

Typically, the K parameter group sets are respectively allocated to K BWPs in K serving cells, and the target bit group is applied to the K BWPs.

In one embodiment, the target bit group comprises a Frequency domain resource assignment field.

In one embodiment, the target bit group comprises a Modulation and coding scheme field.

In one embodiment, the target bit group comprises a Frequency domain resource assignment field and a Modulation and coding scheme field.

In one embodiment, the target bit group comprises a HARQ process number field.

In one embodiment, the target bit group comprises a Redundancy version field.

Typically, the K parameter group sets respectively correspond to K BWPs in K serving cells, and all the K BWPs use a same subcarrier spacing.

In one embodiment, the K BWPs all adopt a first subcarrier spacing.

In one subembodiment of the embodiment, only one BWP among multiple BWPs comprised in any of the K serving cells adopts the first subcarrier spacing.

Typically, the K BWPs are predefined in the K serving cells or configured through an RRC signaling.

In one embodiment, values of K BWP-IDs corresponding to the K BWPs are fixed.

In one embodiment, values of K BWP-IDs corresponding to the K BWPs are the same.

In one embodiment, values of K BWP-IDs corresponding to the K BWPs are pre-defined.

In one embodiment, values of K BWP-IDs corresponding to the K BWPs are configured through an RRC signaling.

Typically, the K serving cells respectively correspond to K scheduling indicator values, and all K scheduling indicator values are the same.

In one embodiment, the K scheduling indicator values are K cif-InSchedulingCells, respectively.

In one embodiment, the K scheduling indicator values are respectively K CIF (Carrier Indicator Field) values.

In one embodiment, the K scheduling indicator values are all equal to a first value.

In one subembodiment of the embodiment, the first value is equal to 0.

In one subembodiment of the embodiment, the first value is equal to 8.

In one subembodiment of the embodiment, the first value is configured through an RRC signaling.

### Embodiment 6

Embodiment 6 illustrates a flowchart of a first signal, as shown in FIG. 6. In FIG. 6, a first node U3 and a second node N4 are in communications via a radio link. It is particularly underlined that the order illustrated in the embodiment does not put constraints over sequences of signal transmissions and implementations. Embodiments, sub-embodiments and subsidiary embodiments of embodiment 6 can be applied to embodiment 5 or 7 if no conflict is caused; conversely, embodiments, sub-embodiments, and subsidiary embodiments of either of embodiment 5 or embodiment 7 can be applied to embodiment 6 without conflict.

The first node U3 receives a first signal in step S30.

The second node N4 transmits a first signal in step S40.

In embodiment 6, the K bit groups comprised in the first DCI comprise a first bit group, the first bit group corresponds to a first parameter group set in the K parameter group sets, the first bit group is used to enable a non-dynamic transmission configured by at least one first-type parameter group comprised in the first parameter group set, and the first-type parameter group comprised in the first parameter group set is used to configure the first signal.

In one embodiment, the first-type parameter group comprised in the first parameter group set is used to determine frequency-domain resources occupied by the first signal.

In one embodiment, the first-type parameter group comprised in the first parameter group set is used to determine time-domain resources occupied by the first signal.

In one embodiment, the first-type parameter group comprised in the first parameter group set is used to determine a HARQ process number occupied by the first signal.

In one embodiment, the first-type parameter group comprised in the first parameter group set is used to determine an MCS adopted by the first signal.

In one embodiment, the first signal is generated by a Transport Block (TB).

In one embodiment, a physical-layer channel occupied by the first signal comprises a PDSCH.

In one embodiment, a transmission channel occupied by the first signal comprises a Downlink Shared Channel (DL-SCH).

In one embodiment, the step S30 is taken after the step S11 in embodiment 5.

In one embodiment, the step S40 is taken after the step S21 in embodiment 5.

### Embodiment 7

Embodiment 7 illustrates a flowchart of a second signal, as shown in FIG. 7. In FIG. 7, a first node U5 and a second node N6 are in communications via a radio link. It is particularly underlined that the order illustrated in the embodiment does not put constraints over sequences of signal transmissions and implementations. Embodiments, sub-embodiments and subsidiary embodiments of embodiment 7 can be applied to embodiment 5 or 6 if no conflict is incurred; conversely, embodiments, sub-embodiments, and subsidiary embodiments of either of embodiment 5 or embodiment 6 can be applied to embodiment 7 without conflict.

The first node U5 transmits a second signal in step S50.

The second node N6 receives a second signal in step S60.

In embodiment 7, the K bit groups comprised in the first DCI comprise a second bit group, the second bit group corresponds to a second parameter group set in the K parameter group sets, the second bit group is used to enable a non-dynamic transmission configured by at least one first-type parameter group comprised in the second parameter group set, and the first-type parameter group comprised in the second parameter group set is used to configure the second signal.

In one embodiment, the first-type parameter group comprised in the second parameter group set is used to determine frequency-domain resources occupied by the second signal.

In one embodiment, the first-type parameter group comprised in the second parameter group set is used to determine time-domain resources occupied by the second signal.

In one embodiment, the first-type parameter group comprised in the second parameter group set is used to determine a HARQ process number occupied by the second signal.

In one embodiment, the first-type parameter group comprised in the second parameter group set is used to determine an MCS adopted by the second signal.

In one embodiment, the second signal is generated by a TB.

In one embodiment, a physical-layer channel occupied by the second signal comprises a Physical Uplink Shared Channel (PUSCH).

In one embodiment, a transmission channel occupied by the second signal comprises an Uplink Shared Channel (UL-SCH).

In one embodiment, the step S50 is taken after the step S11 in embodiment 5.

In one embodiment, the step S60 is taken after the step S21 in embodiment 5.

### Embodiment 8

Embodiment 8 illustrates a schematic diagram of K parameter group sets, as shown in FIG. 8. In FIG. 8, the K parameter group sets respectively correspond to parameter group set #0 to parameter group set #(K−1) in the figure, and any parameter group set from the parameter group set #0 to the parameter group set #(K−1) comprises at least one first-type parameter set.

In one embodiment, there at least exists one parameter group set in the parameter group set #0 to the parameter group set #(K−1) comprising multiple first-type parameter groups.

In one embodiment, any parameter group set from the parameter group set #0 to the parameter group set #(K−1) comprises multiple first-type parameter groups.

In one embodiment, the parameter group set #0 to the parameter group set #(K−1) correspond to serving cell #0 to serving cell #(K−1), respectively.

In one embodiment, the first-type parameter group corresponds to partial or all parameters in an SPS-Config IE.

In one embodiment, the first-type parameter group corresponds to partial or all parameters in a ConfiguradGrantConfig IE.

### Embodiment 9

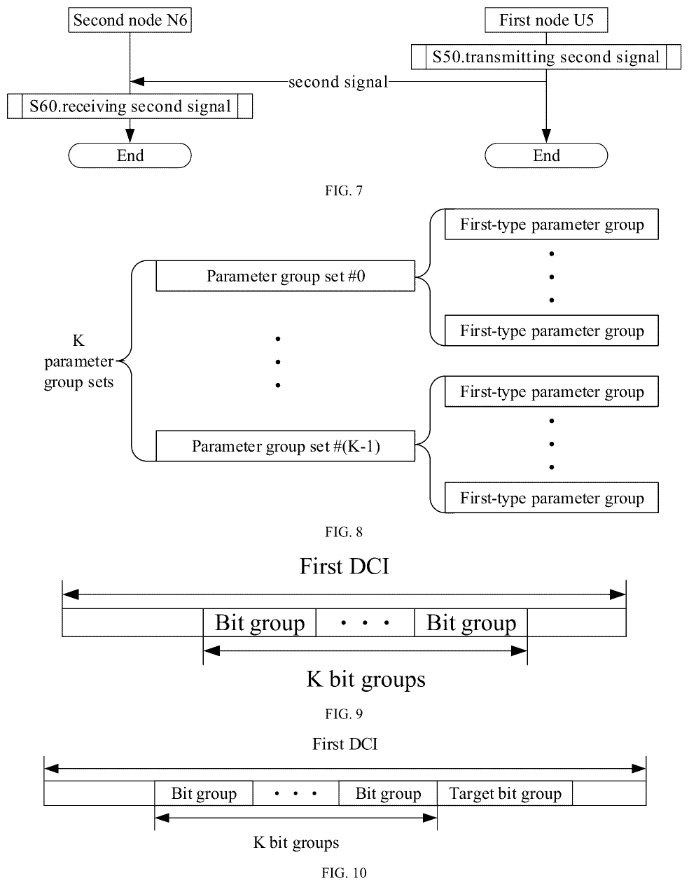

Embodiment 9 illustrates a schematic diagram of K bit groups, as shown in FIG. 9. In FIG. 9, the K bit groups comprised in the first DCI correspond one-to-one with the K parameter group sets.

In one embodiment, any of the K bit groups comprises multiple bits.

In one embodiment, a total number of bits occupied by the K bit groups is related to a bandwidth of K BWPs corresponding to the K serving cells.

In one embodiment, numbers of bits occupied by any two bit groups in the K bit groups are the same.

In one embodiment, a given bit group is any of the K bit groups, the given bit group corresponds to a given parameter group set in the K parameter group set, and the given bit group is used to indicate one or more non-dynamic transmissions corresponding to one or more first-type parameter groups comprised in the given parameter group set.

In one embodiment, a location of the K bit groups in the first DCI is fixed.

In one embodiment, any of the K bit groups comprises at least one of the following fields:
a Frequency domain resource assignment field;
a Modulation and coding scheme field;
a HARQ process number field;
a Redundancy version field.

In one embodiment, any of the K bit groups comprises the following fields:
a Frequency domain resource assignment field;
a Modulation and coding scheme field;
a HARQ process number field;
a Redundancy version field.

### Embodiment 10

Embodiment 10 illustrates a schematic diagram of a target bit group, as shown in FIG. 10. In FIG. 10, the first DCI comprises K bit groups and a target bit group, and only when all the K bit groups are used to disable the validation of the non-dynamic transmission, the target bit group is used to disable the validation of the non-dynamic transmission.

In one embodiment, the target bit group is used to disable the validation of a non-dynamic transmission corresponding to all first-type parameter groups indicated by the K bit groups.

In one embodiment, a number of bits occupied by the target bit group is unrelated to a number of bits comprised in any of the K bit groups.

In one embodiment, a number of bits occupied by the target bit group is fixed.

### Embodiment 11

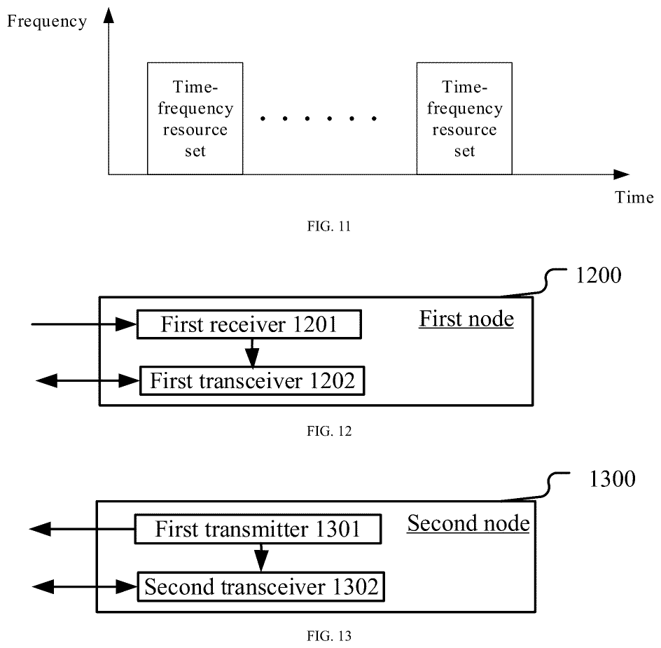

Embodiment 11 illustrates a schematic diagram of a non-dynamic transmission, as shown in FIG. 11. In FIG. 11, the non-dynamic transmission comprises M1 radio signals, and the M1 radio signals occupy M1 time-frequency resource sets, M1 being a positive integer greater than 1.

In one embodiment, the M1 radio signals are respectively generated by M1 different TBs.

In one embodiment, at least two radio signals in the M1 radio signals are generated by a same TB.

In one embodiment, the M1 time-frequency resource sets are periodically divided.

In one embodiment, the M1 radio signals correspond to a same DL SPS.

In one embodiment, the M1 radio signals correspond to a same UL Configured Grant.

### Embodiment 12

Embodiment 12 illustrates a structure block diagram in a first node, as shown in FIG. 12. In FIG. 12, a first node 1200 comprises a first receiver 1201 and a first transceiver 1202.

The first receiver 1201 receives a first signaling, the first signaling is used to determine K parameter group sets, K being a positive integer greater than 1, each of the K parameter group sets comprises at least one first-type parameter group, the first-type parameter group is used to configure a non-dynamic transmission;
the first transceiver 1202 receives a first DCI, the first DCI comprises K bit groups, any of the K bit groups comprises at least one bit;

In embodiment 12, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the first DCI comprises a target bit group other than the K bit groups, and only when all the K bit groups are used to disable the validation of the non-dynamic transmission, the target bit group is used to disable the validation of the non-dynamic transmission.

In one embodiment, the first transceiver 1202 receives a first signal; the K bit groups comprised in the first DCI comprise a first bit group, the first bit group corresponds to a first parameter group set in the K parameter group sets, the first bit group is used to enable a non-dynamic transmission configured by at least one first-type parameter group comprised in the first parameter group set, and the first-type parameter group comprised in the first parameter group set is used to configure the first signal.

In one embodiment, the first transceiver 1202 transmits a second signal; the K bit groups comprised in the first DCI comprise a second bit group, the second bit group corresponds to a second parameter group set in the K parameter group sets, the second bit group is used to enable a non-dynamic transmission configured by at least one first-type parameter group comprised in the second parameter group set, and the first-type parameter group comprised in the second parameter group set is used to configure the second signal.

In one embodiment, the K parameter group sets respectively correspond to K BWPs in K serving cells, and all the K BWPs use a same subcarrier spacing.

In one embodiment, the K BWPs are predefined in the K serving cells or configured through an RRC signaling.

In one embodiment, the K serving cells respectively correspond to K scheduling indicator values, and all K scheduling indicator values are the same.

In one embodiment, the first receiver 1201 comprises at least first four of the antenna 452, the receiver 454, the multi-antenna receiving processor 458, the receiving processor 456 and the controller/processor 459 in Embodiment 4.

In one embodiment, the first transceiver 1202 comprises at least first six of the antenna 452, the receiver 454, the transmitter 454, the multi-antenna transmitter 457, the transmitting processor 468, the multi-antenna receiving processor 458, the receiving processor 456 and the controller/processor 459 in Embodiment 4.

In one embodiment, the first signaling comprises an RRC signaling, the first signaling is used to determine K parameter group sets, and each of the K parameter group sets comprising at least one first-type parameter group is used to configure a non-dynamic transmission; the first-type parameter group corresponds to a configuration parameter group of DL SPS, or the first-type parameter group corresponds to a configuration parameter group of UL configured grant, and the first DCI comprises K bit groups; the K bit groups correspond one-to-one with the K parameter group sets; any of the K bit groups is used to enable a validation of the non-dynamic transmission or disable a validation of the non-dynamic transmission; a given bit group in the K bit groups being used to enable or disable a validation of the non-dynamic transmission is unrelated to a value of a bit group other than the given bit group in the K bit groups.

### Embodiment 13

Embodiment 13 illustrates a structure block diagram of in a second node, as shown in FIG. 13. In FIG. 13, a second node 1300 comprises a first transmitter 1301 and a second transceiver 1302.

The first transmitter 1301 transmits a first signaling, the first signaling is used to determine K parameter group sets, K being a positive integer greater than 1, each of the K parameter group sets comprises at least one first-type parameter group, and the first-type parameter group is used to configure a non-dynamic transmission;
the second transceiver 1302 transmits a first DCI, the first DCI comprises K bit groups, and any of the K bit groups comprises at least one bit;
in embodiment 13, the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

In one embodiment, the first DCI comprises a target bit group other than the K bit groups, and only when all the K bit groups are used to disable the validation of the non-dynamic transmission, the target bit group is used to disable the validation of the non-dynamic transmission.

In one embodiment, the second transceiver 1302 transmits a first signal; the K bit groups comprised in the first DCI comprise a first bit group, the first bit group corresponds to a first parameter group set in the K parameter group sets, the first bit group is used to enable a non-dynamic transmission configured by at least one first-type parameter group comprised in the first parameter group set, and the first-type parameter group comprised in the first parameter group set is used to configure the first signal.

In one embodiment, the second transceiver 1302 receives a second signal; the K bit groups comprised in the first DCI comprise a second bit group, the second bit group corresponds to a second parameter group set in the K parameter group sets, the second bit group is used to enable a non-dynamic transmission configured by at least one first-type parameter group comprised in the second parameter group set, and the first-type parameter group comprised in the second parameter group set is used to configure the second signal.

In one embodiment, the K parameter group sets respectively correspond to K BWPs in K serving cells, and all the K BWPs use a same subcarrier spacing.

In one embodiment, the K BWPs are predefined in the K serving cells or configured through an RRC signaling.

In one embodiment, the K serving cells respectively correspond to K scheduling indicator values, and all K scheduling indicator values are the same.

In one embodiment, the first transmitter 1301 comprises at least first four of the antenna 420, the transmitter 418, the multi-antenna transmitting processor 471, the transmitting processor 414 and the controller/processor 475 in embodiment 4.

In one embodiment, the second transceiver 1302 comprises at least the first six of the antenna 420, the receiver 418, the multi-antenna receiving processor 472, the receiving processor 470, the transmitter 418, the multi-antenna transmitting processor 471, the transmitting processor 414, and the controller/processor 475 in embodiment 4.

In one embodiment, the first signaling comprises an RRC signaling, the first signaling is used to determine K parameter group sets, and each of the K parameter group sets comprising at least one first-type parameter group is used to configure a non-dynamic transmission; the first-type parameter group corresponds to a configuration parameter group of DL SPS, or the first-type parameter group corresponds to a configuration parameter group of UL configured grant, and the first DCI comprises K bit groups; the K bit groups correspond one-to-one with the K parameter group sets; any of the K bit groups is used to enable a validation of the non-dynamic transmission or disable a validation of the non-dynamic transmission; a given bit group in the K bit groups being used to enable or disable a validation of the non-dynamic transmission is unrelated to a value of a bit group other than the given bit group in the K bit groups.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, cars, RSUs, aircrafts, diminutive airplanes, unmanned aerial vehicles, telecontrolled aircrafts and other wireless communication devices. The second node in the present application includes but is not limited to macro-cellular base stations, femtocell, micro-cellular base stations, home base stations, relay base station, eNB, gNB, Transmitter Receiver Point (TRP), GNSS, relay satellites, satellite base stations, space base stations, RSUs, Unmanned Aerial Vehicle (UAV), test devices, for example, a transceiver or a signaling tester simulating some functions of a base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
a first transceiver, receiving a first DCI, the first DCI comprising K bit groups, any of the K bit groups comprising at least one bit;
wherein the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

2. The first node according to claim 1, wherein the first DCI comprises a target bit group other than the K bit groups, and only when all the K bit groups are used to disable the validation of the non-dynamic transmission, the target bit group is used to disable the validation of the non-dynamic transmission.

3. The first node according to claim 1, comprising:
the first transceiver, receiving a first signal;
wherein the K bit groups comprised in the first DCI comprise a first bit group, the first bit group corresponds to a first parameter group set in the K parameter group sets, the first bit group is used to enable a non-dynamic transmission configured by at least one first-type parameter group comprised in the first parameter group set, and the first-type parameter group comprised in the first parameter group set is used to configure the first signal.

4. The first node according to claim 1, comprising:
the first transceiver, transmitting a second signal;
wherein the K bit groups comprised in the first DCI comprise a second bit group, the second bit group corresponds to a second parameter group set in the K parameter group sets, the second bit group is used to enable a non-dynamic transmission configured by at least one first-type parameter group comprised in the second parameter group set, and the first-type parameter group comprised in the second parameter group set is used to configure the second signal.

5. The first node according to claim 1, wherein the K parameter group sets respectively correspond to K BWPs in K serving cells, and all the K BWPs use a same subcarrier spacing.

6. The first node according to claim 5, wherein the K BWPs are predefined in the K serving cells or configured through an RRC signaling.

7. The first node according to claim 5, wherein the K serving cells respectively correspond to K scheduling indicator values, and all K scheduling indicator values are the same.

8. The first node according to claim 1, wherein the non-dynamic transmission is activated through a dynamic signaling.

9. The first node according to claim 1, wherein the non-dynamic transmission is disabled or released through a dynamic signaling.

10. The first node according to claim 1, wherein the non-dynamic transmission comprises multiple transmissions, and at least one of the multiple transmissions does not require an indication through a dynamic signaling.

11. The first node according to claim 1, wherein the non-dynamic transmission comprises SPS, or the non-dynamic transmission comprises configured grant.

12. The first node according to claim 1, wherein at least two of the K bit groups are respectively used to enable and disable at least one first-type parameter group in a corresponding parameter group set.

13. The first node according to claim 1, wherein the K parameter group sets are respectively allocated to K BWPs, and the K bit groups are respectively used to indicate the K BWPs.

14. The first node according to claim 1, wherein the K parameter group sets are respectively allocated to K serving cells, and the K bit groups are respectively used to indicate the K serving cells; or, the K parameter group sets are respectively allocated to K carriers, and the K bit groups are respectively used to indicate the K carriers.

15. The first node according to claim 1, wherein the meaning of at least one first-type parameter group in a corresponding parameter group set being adopted includes:
the corresponding parameter group set comprises a given first-type parameter group, the given first-type parameter group comprises multiple parameters, the multiple parameters comprises at least one of a number of HARQ (Hybrid Automatic Repeat reQuest) processes, PUCCH (Physical Uplink Control Channel) resource indication, MCS (Modulation Coding Scheme) table, HRAQ process number offset, periodic configuration, HARQ codebook identifier, or aggregation factor, and at least one of the multiple parameters is used to determine a data reception of a non-dynamic transmission corresponding to the given first-type parameter group.

16. The first node according to claim 1, wherein the meaning of at least one first-type parameter group in a corresponding parameter group set being adopted includes:
the corresponding parameter group set comprises a given first-type parameter group, the given first-type parameter group comprises multiple parameters, the multiple parameters comprise at least one field in ConfiguredGrantConfig IE, and at least one of the multiple parameters is used to determine a data transmission of a non-dynamic transmission corresponding to the given first-type parameter group.

17. The first node according to claim 1, wherein the meaning of at least one first-type parameter group in a corresponding parameter group set being stopped to be adopted includes:
the corresponding parameter group set comprises a given first-type parameter group, the given first-type parameter group comprises multiple parameters, the multiple parameters comprises at least one of a number of HARQ (Hybrid Automatic Repeat reQuest) processes, PUCCH (Physical Uplink Control Channel) resource indication, MCS (Modulation Coding Scheme) table, HRAQ process number offset, periodic configuration, HARQ codebook identifier, or aggregation factor, and at least one of the multiple parameters is used to determine that a data reception of a non-dynamic transmission corresponding to the given first-type parameter group is stopped.

18. The first node according to claim 1, wherein the meaning of at least one first-type parameter group in a corresponding parameter group set being stopped to be adopted includes:
the corresponding parameter group set comprises a given first-type parameter group, the given first-type parameter group comprises multiple parameters, the multiple parameters comprise at least one field in ConfiguredGrantConfig IE, and at least one of the multiple parameters is used to determine that a data transmission of a non-dynamic transmission corresponding to the given first-type parameter group is stopped.

19. A second node for wireless communications, comprising:
a first transmitter, transmitting a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
a second transceiver, transmitting a first DCI, the first DCI comprising K bit groups, any of the K bit groups comprising at least one bit;
wherein the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.

20. A method in a first node for wireless communications, comprising:
receiving a first signaling, the first signaling being used to determine K parameter group sets, K being a positive integer greater than 1, each parameter group set in the K parameter group sets comprising at least one first-type parameter group, the first-type parameter group being used to configure a non-dynamic transmission; and
receiving a first DCI, the first DCI comprising K bit groups, any of the K bit groups comprising at least one bit;
wherein the K bit groups correspond one-to-one with the K parameter group sets; any of the K bit groups is used to enable or disable a validation of the non-dynamic transmission; a given bit group is any bit group in the K bit groups, and the given bit group in the K bit groups being used to enable or disable a validation of the non-dynamic transmission is unrelated to a value of a bit group other than the given bit group in the K bit groups; for the given bit group in the K bit groups, when being used to enable a validation of the non-dynamic transmission, at least one first-type parameter group in a corresponding parameter group set is adopted, and when being used to disable a validation of the non-dynamic transmission, at least one first-type parameter group in a corresponding parameter group set is stopped from being adopted.
